(19) United States
(12) Patent Application Publication
(10) Pub. No.: US 2022/0284820 A1
(43) Pub. Date: Sep. 8, 2022

(54) METHOD AND SYSTEM FOR MONITORING UNMANNED AERIAL VEHICLE

(71) Applicant: SZ DJI TECHNOLOGY CO., LTD., Shenzhen (CN)

(72) Inventors: Liangliang YANG, Shenzhen (CN); Ming CHEN, Shenzhen (CN)

(21) Appl. No.: 17/751,442

(22) Filed: May 23, 2022

Related U.S. Application Data
(63) Continuation of application No. PCT/CN2019/120654, filed on Nov. 25, 2019.

(51) Int. Cl. G08G 5/00; H04H 20/53; H04H 40/27; B64C 39/02; G05D 1/00

(52) U.S. Cl. CPC G08G 5/0004; H04H 20/53; H04H 40/27; B64C 39/024; G05D 1/0044

(57) ABSTRACT

A method for monitoring an unmanned aerial vehicle (UAV) includes: acquiring, by a processor of the UAV, a UAV monitoring message, wherein the UAV monitoring message includes information on one or more of: identification information related to the UAV and status information related to the UAV; composing, by the processor of the UAV, a Service Discovery Frame (SDF) carrying the UAV monitoring message, the SDF being compliant with a Neighbor Awareness Networking (NAN) protocol; wirelessly broadcasting, by the UAV, the SDF carrying the UAV monitoring message; receiving the broadcasted SDF by a user terminal; acquiring the UAV monitoring message from the received SDF by the user terminal; and outputting the UAV monitoring message through an interface of the user terminal.

### CROSS-REFERENCE TO RELATED APPLICATION

This application is a continuation of International Application No. PCT/CN2019/120654, filed Dec. 11, 2019, the entire content of which is incorporated herein by reference.

### TECHNICAL FIELD

The present disclosure relates to the technical field of remote monitoring methods, in particular to a method for monitoring an unmanned aerial vehicle (UAV).

### BACKGROUND

With the rapid development of unmanned aerial vehicle (UAV) technology, the number of UAVs being in use has been increasing dramatically. Impacts of civilian UAVs on national security, public safety and aviation safety is of significant concern. Methods for monitoring UAVs are under investigation and development aiming to ensure visibility and management of UAV flights. However, civilian UAVs, especially small consumer UAVs, are difficult to monitor due to factors such as low flight altitude, low speed, and small size. Improved monitoring technologies are needed to minimize safety impact and concerns of UAVs on security and safety.

### SUMMARY

In one aspect of the present disclosure, a method for monitoring an unmanned aerial vehicle (UAV). The method includes: acquiring, by a processor of the UAV, a UAV monitoring message, wherein the UAV monitoring message includes information on one or more of: identification information of the UAV and status information related to the UAV; composing, by the processor of the UAV, a Service Discovery Frame (SDF) carrying the UAV monitoring message, the SDF being compliant with a Neighbor Awareness Networking (NAN) protocol; wirelessly broadcasting, by the UAV, the SDF carrying the UAV monitoring message; receiving the broadcasted SDF by a user terminal; acquiring the UAV monitoring message from the received SDF by the user terminal; and outputting the UAV monitoring message through an interface of the user terminal.

In certain embodiments of the method, composing the Service Discovery Frame (SDF) includes writing the UAV monitoring message into a NAN Attribute field of the SDF.

In certain embodiments of the method, composing the Service Discovery Frame (SDF) includes writing the UAV monitoring message into a Service Info field of the NAN Attribute field of the SDF.

In certain embodiments of the method, broadcasting the SDF carrying the UAV monitoring message includes broadcasting the SDF in a 2.437 GHz wireless frequency channel; and the method further includes scanning the 2.437 GHz wireless frequency channel by the user terminal to receive the broadcasted SDF.

In certain embodiments of the method, wirelessly broadcasting the SDF carrying the UAV monitoring message includes broadcasting the SDF through an omnidirectional antenna.

In certain embodiments of the method, broadcasting the SDF comprises periodically broadcasting the SDF with a fixed repetition frequency.

In certain embodiments of the method, broadcasting the SDF comprises periodically broadcasting the SDF with a time-varying repetition frequency correlated to a flight speed of the UAV.

In certain embodiments of the method, the UAV monitoring message includes a static message and a dynamic message; and broadcasting the SDF carrying the UAV monitoring message includes: broadcasting a first SDF carrying the static message at a first repetition frequency; and broadcasting a second SDF carrying the dynamic message at a second repetition frequency.

In certain embodiments of the method, the static message includes information on one or more of: identification information of the UAV, a flight plan of the UAV, pilot information, and a take-off location; and the dynamic message includes a flight status of the UAV, the flight status of the UAV including one or more of: a current position of the UAV, a current height of the UAV, a current flight velocity of the UAV, a current attitude of the UAV.

In certain embodiments of the method, the first repetition frequency is at least (⅓) Hz; and the second repetition frequency is at least 1 Hz.

In certain embodiments of the method, the first repetition frequency and the second repetition frequency are time-varying frequencies corresponding to a flight speed of the UAV.

In certain embodiments of the method, the user terminal is a smart phone or a tablet computing device.

In certain embodiments of the method, the user terminal runs an Android operating system.

In certain embodiments of the method, receiving the broadcasted SDF by a user terminal includes: subscribing to a NAN Service via a software application installed on the user terminal; and activating, by running the software application installed on the user terminal, the user terminal to scan one or more wireless frequency channels pre-defined by the subscribed NAN Service to cause the user terminal to receive the broadcasted SDF.

In certain embodiment, the method further includes: configuring a Service Name data field of the software application to match a Service Name data field of the SDF broadcasted by the UAV, or configuring a Service ID data field of the software application to match a Service ID data field of the SDF broadcasted by the UAV.

In certain embodiments of the method, the UAV monitoring message includes a current position of the UAV; and the method further comprises: displaying a map on the interface of the user terminal; and displaying an icon of the UAV on the map corresponding to the current position of the UAV.

In certain embodiments of the method, the UAV monitoring message includes a type of the UAV; and displaying the icon of the UAV on the map includes: displaying a first icon if the UAV is a first type of UAV; and displaying a second icon if the UAV is a second type of UAV.

In certain embodiments of the method, outputting the UAV monitoring message through the interface comprises displaying one of more of: an operational status of the UAV, a longitude coordinate of the UAV, a latitude coordinate of the UAV, an altitude of the UAV according to the WGS 84 standard, a height of the UAV according to the barometer unit, a vertical speed of the UAV, and a horizontal speed of the UAV.

In certain embodiments, the method further includes calculating one or more of: a UAV-to-controller distance according to a current position of the UAV and a current position of a remote controller of the UAV by the user terminal; a UAV-to-take-off distance according to a current position of the UAV and a take-off position of the UAV by the user terminal; and a UAV-to-terminal distance according to a current position of the UAV and a current position of the user terminal by the user terminal; and displaying one or more of: the UAV-to-take-off distance, the UAV-to-take-off distance, and the UAV-to-terminal distance through the interface.

In another aspect of the present disclosure, a system for monitoring an unmanned aerial vehicle (UAV) is provided. The system includes the UAV and a user terminal. The UAV is configured to: acquire a UAV monitoring message, wherein the UAV monitoring message includes information on one or more of: identification information of the UAV and status information related to the UAV; compose a Service Discovery Frame (SDF) carrying the UAV monitoring message, the SDF being compliant with a Neighbor Awareness Networking (NAN) protocol; and wirelessly broadcast the SDF carrying the UAV monitoring message. The user terminal is configured to: receive the broadcasted SDF; acquire the UAV monitoring message from the received SDF; and output the UAV monitoring message through an interface of the user terminal.

In certain embodiments of the system, the UAV is further configured to write the UAV monitoring message into a NAN Attribute field of the SDF.

In certain embodiments of the system, the UAV is further configured to write the UAV monitoring message into a Service Info field of the NAN Attribute field of the SDF.

In certain embodiments of the system, the UAV is further configured to broadcast the SDF in a 2.437 GHz wireless frequency channel; and the user terminal is further configured to scan the 2.437 GHz wireless frequency channel to receive the broadcasted SDF.

In certain embodiments of the system, the UAV is further configured to broadcast the SDF through an omnidirectional antenna.

In certain embodiments of the system, the UAV is further configured to periodically broadcast the SDF with a fixed repetition frequency.

In certain embodiments of the system, the UAV is further configured to periodically broadcast the SDF with a time-varying repetition frequency correlated to a flight speed of the UAV.

In certain embodiments of the system, the UAV monitoring message comprises a static message and a dynamic message; and the UAV is further configured to: broadcast a first SDF carrying the static message at a first repetition frequency; and broadcast a second SDF carrying the dynamic message at a second repetition frequency.

In certain embodiments of the system, the static message includes information on one or more of: identification information of the UAV, a flight plan of the UAV, pilot information, and a take-off location; and the dynamic message includes a flight status of the UAV, the flight status of the UAV including one or more of: a current position of the UAV, a current height of the UAV, a current flight velocity of the UAV, a current attitude of the UAV.

In certain embodiments of the system, the first repetition frequency is at least (⅓) Hz; and the second repetition frequency is at least 1 Hz.

In certain embodiments of the system, the first repetition frequency and the second repetition frequency are time-varying frequencies corresponding to a flight speed of the UAV.

In certain embodiments of the system, the user terminal is a smart phone or a tablet computing device.

In certain embodiments of the system, the user terminal runs an Android operating system.

In certain embodiments of the system, the user terminal is further configured to: subscribe to a NAN Service via a software application installed on the user terminal; and scan, by running the software application installed on the user terminal, one or more wireless frequency channels pre-defined by the subscribed NAN Service to cause the user terminal to receive the broadcasted SDF.

In certain embodiments of the system, the user terminal is further configured to configure a Service Name data field of the software application to match a Service Name data field of the SDF broadcasted by the UAV, or configure a Service ID data field of the software application to match a Service ID data field of the SDF broadcasted by the UAV.

In certain embodiments of the system, the UAV monitoring message includes a current position of the UAV; and the user terminal if further configured to: display a map on the interface of the user terminal; and display an icon of the UAV on the map corresponding to the current position of the UAV.

In certain embodiments of the system, the UAV monitoring message includes a type of the UAV; and the user terminal if further configured to: display a first icon if the UAV is a first type of UAV; and display a second icon if the UAV is a second type of UAV.

In certain embodiments of the system, the user terminal if further configured to display one of more of: an operational status of the UAV, a longitude coordinate of the UAV, a latitude coordinate of the UAV, an altitude of the UAV according to the WGS 84 standard, a height of the UAV according to the barometer unit, a vertical speed of the UAV, and a horizontal speed of the UAV.

In certain embodiments of the system, the user terminal is further configured to: calculate one or more of: a UAV-to-controller distance according to a current position of the UAV and a current position of a remote controller of the UAV by the user terminal, a UAV-to-take-off distance according to a current position of the UAV and a take-off position of the UAV by the user terminal, and a UAV-to-terminal distance according to a current position of the UAV and a current position of the user terminal by the user terminal; and display one or more of: the UAV-to-take-off distance, the UAV-to-take-off distance, and the UAV-to-terminal distance through the interface.

In another aspect of the present disclosure, an unmanned aerial vehicle (UAV) is provided. The UAV includes: a wi-fi communication component; and a processor configured to: acquire a UAV monitoring message, wherein the UAV monitoring message includes information on one or more of: identification information of the UAV and status information related to the UAV; compose a Service Discovery Frame (SDF) carrying the UAV monitoring message, the SDF being compliant with a Neighbor Awareness Networking (NAN) protocol; and control the wi-fi communication component to wirelessly broadcast the SDF carrying the UAV monitoring message to cause a user terminal to receive the broadcasted SDF and output the UAV monitoring message through an interface of the user terminal.

In certain embodiments of the UAV, the processor is further configured to write the UAV monitoring message into a NAN Attribute field of the SDF.

In certain embodiments of the UAV, the processor is further configured to write the UAV monitoring message into a Service Info field of the NAN Attribute field of the SDF.

In certain embodiments, the UAV is further configured broadcast the SDF in a 2.437 GHz wireless frequency channel.

In certain embodiments of the UAV, the SDF is broadcasted through an omnidirectional antenna.

In certain embodiments, the UAV is further configured to periodically broadcast the SDF with a fixed repetition frequency.

In certain embodiments, the UAV is further configured to periodically broadcast the SDF with a time-varying repetition frequency correlated to a flight speed of the UAV.

In certain embodiments of the UAV, the UAV monitoring message comprises a static message and a dynamic message; and the UAV is further configured to: broadcast a first SDF carrying the static message at a first repetition frequency; and broadcast a second SDF carrying the dynamic message at a second repetition frequency.

In certain embodiments of the UAV, the static message includes information on one or more of: identification information of the UAV, a flight plan of the UAV, pilot information, and a take-off location; and the dynamic message includes a flight status of the UAV, the flight status of the UAV including one or more of: a current position of the UAV, a current height of the UAV, a current flight velocity of the UAV, a current attitude of the UAV.

In certain embodiments of the UAV, the first repetition frequency is at least (⅓) Hz; and the second repetition frequency is at least 1 Hz.

In certain embodiments of the UAV, the first repetition frequency and the second repetition frequency are time-varying frequencies corresponding to a flight speed of the UAV.

In certain embodiments of the UAV, the UAV monitoring message includes a current position of the UAV.

In certain embodiments of the UAV, the UAV monitoring message includes a type of the UAV.

In another aspect of the present disclosure, a non-transient computer-readable medium is provided. The non-transient computer-readable medium stores computer-executable instructions which, when being executed by a user terminal, cause the user terminal to: receive a Service Discovery Frame (SDF) broadcasted by an unmanned aerial vehicle (UAV), the SDF being compliant with a Neighbor Awareness Networking (NAN) protocol and carrying a UAV monitoring message including at least one of identification information related to the UAV or the status information related to the UAV; acquire the UAV monitoring message from the received SDF; and output the UAV monitoring message through an interface of the user terminal.

In certain embodiments of the non-transient computer-readable medium, the computer-executable instructions further cause the user terminal to: extract a NAN Attribute field from the received SDF; and acquire the UAV monitoring message from the NAN Attribute field.

In certain embodiments of the non-transient computer-readable medium, the computer-executable instructions further cause the user terminal to: extract a Service Info field from the NAN Attribute field of the SDF; and acquire the UAV monitoring message from the Service Info field.

In certain embodiments of the non-transient computer-readable medium, the computer-executable instructions further cause the user terminal to: scan a 2.437 GHz wireless frequency channel to receive the broadcasted SDF.

In certain embodiments of the non-transient computer-readable medium, the UAV monitoring message comprises a static message and a dynamic message.

In certain embodiments of the non-transient computer-readable medium, the static message includes information on one or more of: identification information of the UAV, a flight plan of the UAV, pilot information, and a take-off location; and the dynamic message includes a flight status of the UAV, the flight status of the UAV including one or more of: a current position of the UAV, a current height of the UAV, a current flight velocity of the UAV, a current attitude of the UAV.

In certain embodiments of the non-transient computer-readable medium, the user terminal is a smart phone or a tablet computing device.

In certain embodiments of the non-transient computer-readable medium, the user terminal runs an Android operating non-transient computer-readable medium.

In certain embodiments of the non-transient computer-readable medium, the computer-executable instructions further cause the user terminal to: subscribe to a NAN Service; and scan one or more wireless frequency channels pre-defined by the subscribed NAN Service to cause the user terminal to receive the broadcasted SDF.

In certain embodiments of the non-transient computer-readable medium, the computer-executable instructions further cause the user terminal to: configure a Service Name data field of the software application to match a Service Name data field of the SDF broadcasted by the UAV, or configure a Service ID data field of the software application to match a Service ID data field of the SDF broadcasted by the UAV.

In certain embodiments of the non-transient computer-readable medium, the UAV monitoring message includes a current position of the UAV; and the computer-executable instructions further cause the user terminal to: display a map on the interface of the user terminal; and display an icon of the UAV on the map corresponding to the current position of the UAV.

In certain embodiments of the non-transient computer-readable medium, the UAV monitoring message includes a type of the UAV; and the computer-executable instructions further cause the user terminal to: display a first icon if the UAV is a first type of UAV; and display a second icon if the UAV is a second type of UAV.

In certain embodiments of the non-transient computer-readable medium, the computer-executable instructions further cause the user terminal to display one of more of: an operational status of the UAV, a longitude coordinate of the UAV, a latitude coordinate of the UAV, an altitude of the UAV according to the WGS 84 standard, a height of the UAV according to the barometer unit, a vertical speed of the UAV, and a horizontal speed of the UAV.

In certain embodiments of the non-transient computer-readable medium, the computer-executable instructions further cause the user terminal to: calculate one or more of: a UAV-to-controller distance according to a current position of the UAV and a current position of a remote controller of the UAV by the user terminal, a UAV-to-take-off distance according to a current position of the UAV and a take-off position of the UAV by the user terminal, and a UAV-to-terminal distance according to a current position of the UAV and a current position of the user terminal by the user terminal; and display one or more of: the UAV-to-take-off distance, the UAV-to-take-off distance, and the UAV-to-terminal distance through the interface.

### BRIEF DESCRIPTION OF THE DRAWINGS

In order to more clearly illustrate the technical solutions in the embodiments of the present disclosure, the drawings used in the description of the embodiments will be briefly described below. It is obvious that the drawings in the following description are only some embodiments of the present disclosure. Other drawings may be obtained by those of ordinary skill in the art based on these drawings.

FIG. 1 shows a configuration of a UAV monitoring system according to certain embodiments;

FIG. 2 shows a method for monitoring an unmanned aerial vehicle (UAV) according to certain embodiments;

FIG. 3 shows an example of a predefined format of the UAV monitoring message;

FIG. 4 shows an example of the Message Body data field of the UAV monitoring message according to certain embodiments;

FIG. 5 shows an example of the Message Content sub-field according to certain embodiments;

FIG. 6 shows an example of a format of a NAN Service Discovery Frame (SDF);

FIG. 7 shows another example of a format of a NAN Service Discovery Frame (SDF) having extended attributes;

FIG. 8 shows a process of receiving the broadcasted SDF by the user terminal (Step S205) according to certain embodiments;

FIG. 9 shows an example of outputting the UAV monitoring message through an interface of the user terminal; and

FIG. 10 shows a configuration of a UAV according to certain embodiments.

### DESCRIPTION OF THE EMBODIMENTS

The technical solutions according to the embodiments of the present disclosure described in the following with reference to the accompanying drawings. The described embodiments are only part of the embodiments of the present disclosure, but not all the embodiments. All other embodiments obtained by a person of ordinary skill in the art based on the embodiments of the present disclosure without creative efforts are within the scope of the present disclosure.

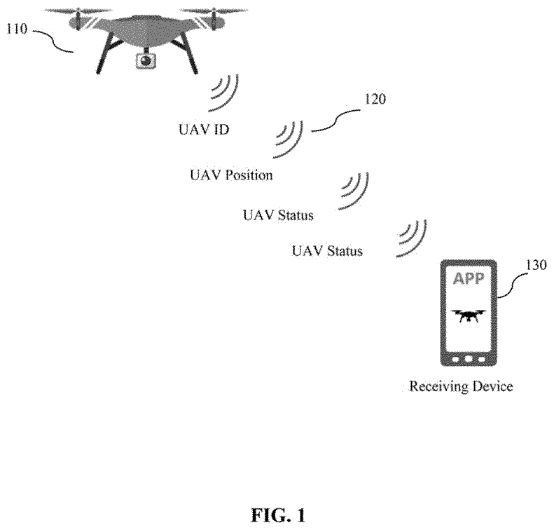

UAVs may wirelessly broadcast identity and location information during flights. A radio receiving device may be used to receive and parse the UAV broadcasted signal on the ground to acquire the identity and location information corresponding to the UAV. FIG. 1 shows a configuration of a UAV monitoring system according to certain embodiments. As shown in FIG. 1, a UAV 110 may wirelessly broadcast a UAV signal 120. The UAV signal 120 may carry information such as a UAV ID, a current location of the UAV, and a current status of the UAV. In certain embodiments, the UAV 110 may actively broadcast the UAV signal 120. A receiving device 130 may receive and parse the UAV signal 120 to acquire the corresponding information. In certain embodiments, the receiving device 130 may be a smart device, such as a smartphone or a tablet. UAV regulatory authorities may use conventional smart mobile devices to remotely identify UAVs, for example, by installing applications (apps) on a smartphone or a tablet. The smart mobile device may be configured to analysis and display of information such as UAV ID and location. In certain other embodiments, the receiving device 130 may be a computing device, such as a personal computer or a server. In certain embodiments, the receiving device 130 may be a ground-based device. In certain other embodiments, the receiving device may be an airborne device, such as being carried on an aerial vehicle. In certain embodiments, the receiving device 130 may be a stationary device. In certain other embodiments, the receiving device 130 may be a moving device.

The wireless broadcasting and receiving of UAV signals may be based on the Wi-Fi technology. Wi-Fi technology is mature, low cost, and widely used for wireless transmission of images and remote commands. A UAV may broadcast its ID and location information via Wi-Fi signals, and a monitoring system may remotely receive the UAV signal using a conventional Wi-Fi enabled smart mobile device.

In order to obtain the packet data such as the UAV ID and location carried by the Wi-Fi signal, the smart mobile device needs to find and use a radio frame with enough capacity to carry adequate information such as the UAV ID and location. Further, the UAV monitoring process needs to be supported by the operating system of the smart mobile device, such as Android or iOS, of the smart device. Preferably, the monitoring system may use public API to obtain the message information carried in the Wi-Fi radio frame. Otherwise, a customized receiver may be needed to receive and parse the message, or to root the smart device to obtain message information, which is often unacceptable to UAV regulatory authorities. However, presently used operating systems of smart devices do not offer an open API that's suitable for UAV monitoring process due to considerations on security, power consumption, stability, and the versatility of the operating system open APIs.

Certain methods have been proposed to assist remotely identify a UAV based on Wi-Fi technology. For example, it has been proposed to use Vendor Specific field of the Beacon frame (Type0, Subtype8) of the Wi-Fi communication protocol to carry the UAV monitoring message. Alternatively, the SSID field of the Beacon frame (Type0, SubType8) of the Wi-Fi communication protocol has been proposed to carry the UAV monitoring message. However, these proposed approaches cannot satisfy the technical conditions for providing comprehensive monitoring of UAVs. Firstly, there may not be enough available field capacity to carry the UAV message data. As a result, the UAV message data needs to be split into multiple short messages. This may increase transmission time, make the system design more complex, and affect normal image transmission service of the UAV using Wi-Fi technology. The increased transmission time may affect real-time refreshing of received data. The transmission and receiving of the multiple short messages may also negatively impact the power efficiency of the system. Secondly, these approaches may not be supported by open APIs of existing operating systems of smart devices, causing the necessity to use a customized or dedicated receiving device, or to root a smart device, which may be unacceptable to the user.

For example, although the Vendor Specific field of the Beacon frame can carry a maximum of 255 bytes of message data, the smart mobile device operating system does not support parsing the field, and the conventional smart mobile device cannot obtain the content of the field. Since the message is transmitted on a random channel, the specific receiving device needs to scan all possible channels, so it is difficult to achieve real-time refreshing of the received data and power saving of the receiving device.

Further, for example, although the system before Android 9.0 has an API that can obtain the monitoring message carried by the SSID in real time, in Android 9.0 and later systems, due to the consideration of smart mobile device security and low power consumption, access to the API interface has been limited to up to 4 times in 2 minutes. This limitation significantly limits the refresh rate of the monitoring system, rendering the smart device unable to update remote monitoring the UAV in real time. The SSID field also has a maximum length of 32 Bytes and requires UTF-8 encoding, limiting the size of carried massage to 26 Bytes. The shorter packet carrying capacity will result in the necessity to split the UAV identification information into multiple short messages. In order to ensure the refresh rate of multiple short messages on the smart device, the UAV must use shorter intervals to broadcast the message, which negatively impacts normal image transmission and wireless control services of the UAV, and decreases power efficiency of the receiving device.

The present disclosure provides a technical solution that addresses the above problems without using a customized receiver or rooting a smart device to realize remote monitoring of the UAV. In one aspect, the present disclosure provides a method for monitoring an unmanned aerial vehicle (UAV).

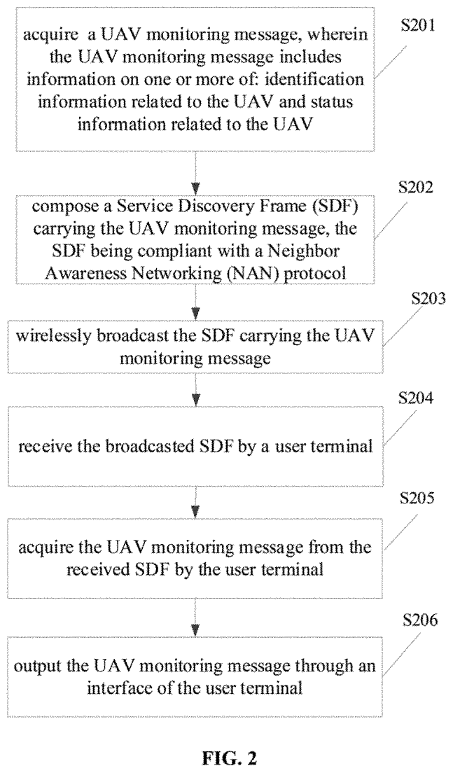

FIG. 2 shows a method for monitoring an unmanned aerial vehicle (UAV) according to certain embodiments. As shown in FIG. 2, the method may include the following steps.

Step S201 is to acquire a UAV monitoring message, wherein the UAV monitoring message includes information on one or more of: identification information of the UAV and status information related to the UAV. In certain embodiments, identification information related to the UAV may be acquired by a processor of the UAV from one or more storage units. The identification information may include a UAV ID or a user ID. In certain embodiments, the UAV ID may be a unique global serial ID of the UAV, which may have been assigned to the UAV and written to the UAV firmware during manufacture process. In certain embodiments, the identification information may include a registration number of the UAV, which may have been provided by a UAV regulatory authority when the owner or the user of the UAV registers the UAV. In certain embodiments, status information related to the UAV may be acquired by the processor of the UAV. In certain embodiments, acquiring status information of the UAV may include retrieving one of more of: an operational status of the UAV, a longitude coordinate of the UAV, a latitude coordinate of the UAV, an altitude of the UAV according to the WGS 84 standard, a height of the UAV according to a barometer unit, a vertical speed of the UAV, a horizontal speed of the UAV, and a flight direction of the UAV. The above information may be retrieved from one or more functional units of the UAV, such as sensing and/or data storage units.

Step 202 is to compose a Service Discovery Frame (SDF) carrying the UAV monitoring message, the SDF being compliant with a Neighbor Awareness Networking (NAN) protocol. In certain embodiments, a processor on the UAV may generate a UAV monitoring message according to the identification information and the status information. In certain embodiments, the UAV monitoring message may include at least one of a static message and a dynamic message. In certain embodiments, the UAV monitoring message may include both the static message and the dynamic message. In certain embodiments, the static message may include information on one or more of: identification information of the UAV, a flight plan of the UAV, pilot information, and a take-off location. The dynamic message may include a flight status of the UAV, the flight status of the UAV including one or more of: a current position of the UAV, a current height of the UAV, a current flight velocity of the UAV, a current attitude of the UAV.

In certain embodiments, the UAV monitoring message may follow a pre-defined format. For example, the UAV monitoring message may include one or more of: a Magic Code data field for storing a message type; a UAV Unique ID data field for storing a unique global ID of the UAV; a UAV Type data field for storing a type of the UAV; a Timestamp data field for storing a timestamp of the message; and a Message Body data field for storing a message body.

In certain embodiments, the Message Body data field of the UAV monitoring message may include one or more of: a Massage ID data sub-field for storing an ID of the UAV message; a Version data sub-field for storing a version of the UAV message; and a Message Content sub-field for storing message content.

In certain embodiments, the Message Content sub-field of the UAV monitoring message may include one or more sub-fields of: a UAV Registration Number sub-field for storing a registration number of the UAV; a UAV Status sub-field for storing an operational status of the UAV; a UAV Longitude sub-field for storing a longitude coordinate of the UAV; a UAV Latitude sub-field for storing a latitude coordinate of the UAV; a UAV Altitude sub-field for storing an altitude of the UAV according to a WGS 84 standard; a UAV Height sub-field for storing a height of the UAV according to a barometer unit; a UAV Vertical Speed sub-field for storing a vertical speed of the UAV; a UAV Horizontal Speed sub-field for storing a horizontal speed of the UAV; a UAV Heading sub-field for storing a flight direction of the UAV; a UAV Take-off Longitude sub-field for storing a take-off longitude of the UAV; a UAV Take-off Latitude sub-field for storing a take-off latitude of the UAV; a UAV Take-off Height sub-field for storing a take-off height of the UAV; a UAV Home Longitude sub-field for storing a home longitude of the UAV; a UAV Home Latitude sub-field for storing a home latitude of the UAV; a Remote Controller Latitude sub-field for storing a remote controller latitude of the UAV; a Remote Controller Longitude sub-field for storing a remote controller longitude of the UAV; a Remote Controller Height sub-field for storing a remote controller height of the UAV; a Data Accuracy sub-field for storing a data accuracy of the UAV message; a Pilot Information sub-field for storing pilot information of the UAV; and a Flight Information sub-field for storing flight information of the UAV.

In certain embodiments, a processor on the UAV may compose a message frame to carry the UAV monitoring message. The message frame may be any frame that is compliant with a NAN protocol. The message frame may have one or more self-defined fields into which the UAV monitoring message may be written into. In certain embodiments, the NAN message frame may be a Service Discovery Frame (SDF) compliant with the NAN protocol. The UAV monitoring message, including the identification information and the status information, may be written into one or more fields of the SDF.

The Neighbor Awareness Networking (NAN) technology is also known as the Wi-Fi Aware technology. The NAN protocol adopts enhanced peer-to-peer communication capabilities to enable Wi-Fi devices to exchange services and information without the need for a network infrastructure or complex setup process. Android Oreo (Android 8.0) and future operating systems provide native support for Wi-Fi Aware APIs. The NAN protocol provides a Service Discovery function. The NAN Service Discovery Frame (SDF) may include a NAN Service Descriptor Attribute field that has multiple sub-fields including a Service Info Length field and a Service Info field. The Service Info field may be used to carry the UAV monitoring message including the UAV identification and status information. The SDF may carry up to 255 bytes of information. In certain embodiments, composing the Service Discovery Frame (SDF) may include writing the UAV monitoring message into the NAN Attribute field of the SDF. In certain embodiments, composing the Service Discovery Frame (SDF) may include writing the UAV monitoring message into the Service Info field of the NAN Attribute field of the SDF.

Step 203 is to wirelessly broadcast the SDF carrying the UAV monitoring message. The NAN SDF that carries the UAV monitoring message may be broadcasted by a Wi-Fi unit of the UAV. In certain embodiments, the SDF carrying the UAV monitoring message may be broadcasted in a fixed frequency channel. For example, the UAV monitoring message may be broadcasted in one or more predefined wireless frequency channels, such as in a 2.437 GHz wireless frequency channel. The NAN protocol specification may cause the SDF to be transmitted in channel 6 (2.437 GHz) of the 2.4 GHz band. The single frequency transmission of the SDF facilitates real-time monitoring of the UAV since there is no need to scan for a range of frequencies to receive the monitoring message by the receiving device. Further, the single frequency transmission of the SDF facilitates implementation by the UAV manufacturer. In certain embodiments, the SDF can be replaced by the message frame.

In certain embodiments, the SDF carrying the UAV monitoring message may be broadcasted an omnidirectional antenna. The omnidirectional antenna may broadcast the SDF with equal power density in all horizontal directions, so that receiving devices distributed around the UAV may receive the SDF with equal efficiency. In certain other embodiments, the SDF carrying the UAV monitoring message may be broadcasted a directional antenna. In this case, the receiving device located in a particular direction to the UAV may preferably receive the broadcasted SDF.

In certain embodiments, the SDF carrying the UAV monitoring message may be broadcasted periodically with a fixed repetition frequency. In certain other embodiments, the SDF carrying the UAV monitoring message may be broadcasted periodically with a time-varying repetition frequency. In certain embodiments, the time-varying repetition frequency of the broadcasting may correlate to a flight speed of the UAV.

In certain embodiments, the UAV monitoring message may include both a static message and a dynamic message. A first SDF may be composed to carry the static message. A second SDF may be composed to carry the dynamic message. Broadcasting the SDF may include: broadcasting the first SDF carrying the static message at a first repetition frequency; and broadcasting the SDF carrying the dynamic message at a second repetition frequency. In certain embodiments, the second repetition frequency may be higher than the first repetition frequency. In certain embodiments, the first repetition frequency may be at least (⅓) Hz. In certain embodiments, the second repetition frequency may be at least 1 Hz. In certain embodiments, the first repetition frequency and the second repetition frequency may be time-varying frequencies corresponding to a flight speed of the UAV. 11. In certain embodiments, the first repetition frequency may be at or above (⅙) Hz when the flight speed of the UAV is at or below 15 m/s, may be at or above (⅓) Hz when the flight speed of the UAV is above 15 m/s and below or at 30 m/s, and may be at or above (1/1.5) Hz when the flight speed of the UAV is above 30 m/s and below or at 50 m/s. In certain embodiments, the second repetition frequency may be at or above (½) Hz when the flight speed of the UAV is at or below 15 m/s; may be at or above 1 Hz when the flight speed of the UAV is above 15 m/s and below or at 30 m/s; and may be at or above 2 Hz when the flight speed of the UAV is above 30 m/s and below or at 50 m/s.

Step 204 is to receive the broadcasted SDF by a user terminal. In certain embodiments, the user terminal may be a smart mobile device such as a smartphone or a tablet. In certain embodiments, the user terminal may scan a fixed wireless frequency channel in which the SDF is broadcasted by the UAV to receive the broadcasted SDF. For example, the user terminal may scan the 2.437 GHz wireless frequency channel to receive the broadcasted SDF.

Step 205 is to acquire the UAV monitoring message from the received SDF by the user terminal. In certain embodiments, a processor of the user terminal may parse the received the received SDF frame to acquire the UAV monitoring message.

Step 206 is to output the UAV monitoring message through an interface of the user terminal. In certain embodiments, the user terminal may output the parsed UAV monitoring message through an interface, so a user may receive the UAV monitoring message, including the identification information and the status information. In certain embodiments, outputting the UAV monitoring message through the interface may include displaying one of more of: a global serial ID of the UAV, a registration number of the UAV, an operational status of the UAV, a longitude coordinate of the UAV, a latitude coordinate of the UAV, an altitude of the UAV according to the WGS 84 standard, a height of the UAV according to the barometer unit, a vertical speed of the UAV, and a horizontal speed of the UAV. In certain embodiments, information within the UAV monitoring message may be outputted in the formats of one or more of: text, graphics, maps, audios, and videos. In certain embodiments, information within the UAV monitoring message may be outputted in multimedia formats.

FIG. 3 shows an example of a predefined format of the UAV monitoring message. As shown in FIG. 3, the UAV monitoring message may include one or more of: a Magic Code data field for storing a message type; a UAV Unique ID data field for storing a unique global ID of the UAV; a UAV Type data field for storing a type of the UAV; a Timestamp data field for storing a timestamp of the message; and a Message Body data field for storing a message body. In one example, the Magic Code data field may have a length of 3 bytes. The UAV Unique ID data field may have length of 20 bytes. The UAV Type data field may have a length of 1 byte. In certain embodiments, the UAV Type data field may store an indicator to indicate whether the UAV being monitored is single-rotor UAV or a multi-rotor UAV.

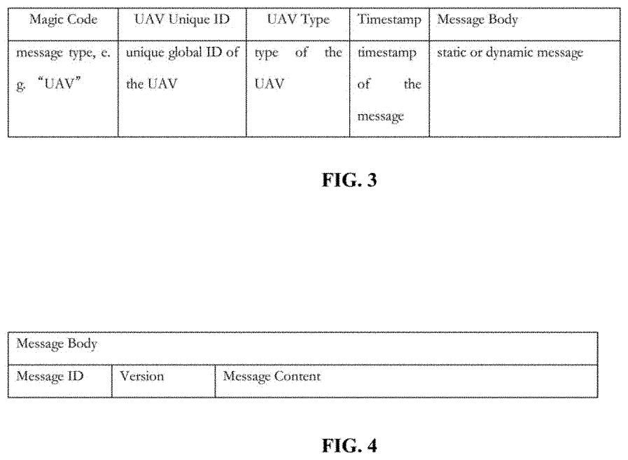

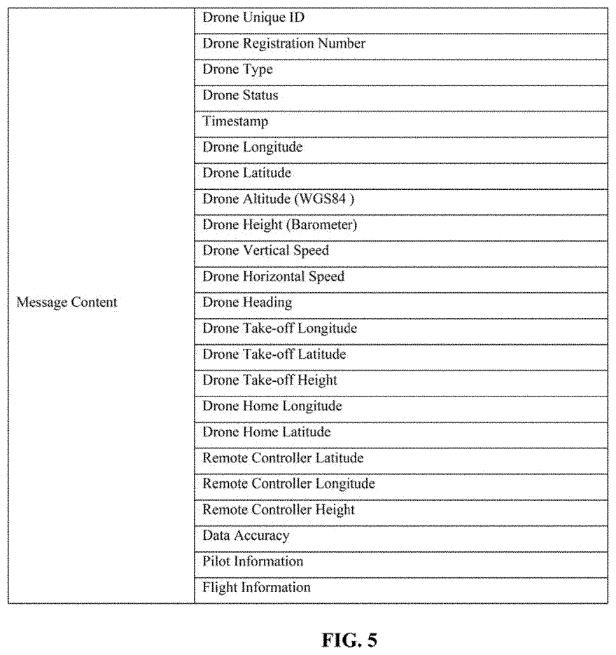

FIG. 4 shows an example of the Message Body data field of the UAV monitoring message according to certain embodiments. As shown in FIG. 4, the Message Body data field may include one or more of: a Massage ID sub-field for storing an ID of the UAV message; a Version sub-field for storing a version of the UAV message; and a Message Content sub-field for storing message content. The Massage ID sub-field may have a length of 1 byte. The Version sub-field may have a length of 1 byte.

FIG. 5 shows an example of the Message Content sub-field according to certain embodiments. As shown in FIG. 5, the Message Content sub-field of the UAV monitoring message may include one or more sub-fields of: a UAV Registration Number sub-field for storing a registration number of the UAV; a UAV Status sub-field for storing an operational status of the UAV; a UAV Longitude sub-field for storing a longitude coordinate of the UAV; a UAV Latitude sub-field for storing a latitude coordinate of the UAV; a UAV Altitude sub-field for storing an altitude of the UAV according to a WGS 84 standard; a UAV Height sub-field for storing a height of the UAV according to a barometer unit; a UAV Vertical Speed sub-field for storing a vertical speed of the UAV; a UAV Horizontal Speed sub-field for storing a horizontal speed of the UAV; a UAV Heading sub-field for storing a flight direction of the UAV; a UAV Take-off Longitude sub-field for storing a take-off longitude of the UAV; a UAV Take-off Latitude sub-field for storing a take-off latitude of the UAV; a UAV Take-off Height sub-field for storing a take-off height of the UAV; a UAV Home Longitude sub-field for storing a home longitude of the UAV; a UAV Home Latitude sub-field for storing a home latitude of the UAV; a Remote Controller Latitude sub-field for storing a remote controller latitude of the UAV; a Remote Controller Longitude sub-field for storing a remote controller longitude of the UAV; a Remote Controller Height sub-field for storing a remote controller height of the UAV; a Data Accuracy sub-field for storing a data accuracy of the UAV message; a Pilot Information sub-field for storing pilot information of the UAV; and a Flight Information sub-field for storing flight information of the UAV.

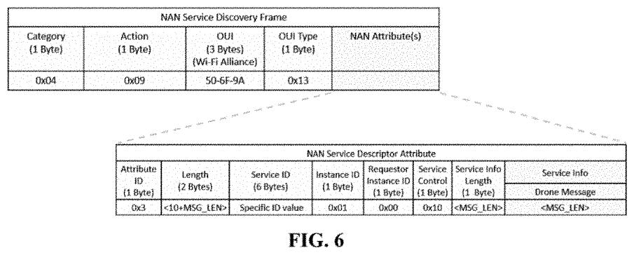

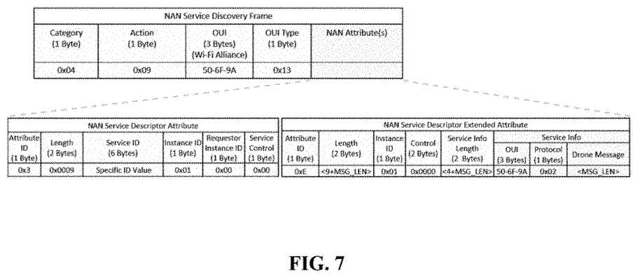

FIG. 6 shows an example of a format of a NAN Service Discovery Frame (SDF). FIG. 7 shows another example of a format of a NAN Service Discovery Frame (SDF) having extended attributes. As shown in FIG. 6 and FIG. 7, the NAN SDF may include a NAN Service Descriptor Attribute field that has multiple sub-fields including a Service Info Length field and a Service Info field. The Service Info field may be used to carry the UAV monitoring message including the UAV identification and status information. The SDF may carry up to 255 bytes of information. In certain embodiments, composing the Service Discovery Frame (SDF) may include writing the UAV monitoring message into the NAN Attribute field of the SDF. In certain embodiments, composing the Service Discovery Frame (SDF) may include writing the UAV monitoring message into the Service Info field of the NAN Attribute field of the SDF.

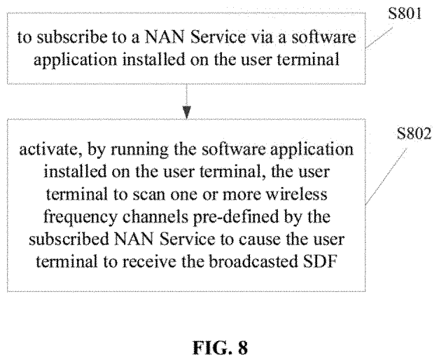

FIG. 8 shows a process of receiving the broadcasted SDF by the user terminal (Step S205) according to certain embodiments. As shown in FIG. 8, receiving the broadcasted SDF by a user terminal may include the following steps.

Step 801 is to subscribe to a NAN Service via a software application installed on the user terminal. In certain embodiments, the user terminal may be a smart device such as a cellphone or a tablet. In certain embodiments, the user terminal may run an Android or IOS operating system. The user terminal may subscribe to the NAN Service of the operating system via an App installed on the user terminal.

Step 802 is to activate, by running the software application installed on the user terminal, the user terminal to scan one or more wireless frequency channels pre-defined by the subscribed NAN Service to cause the user terminal to receive the broadcasted SDF. In certain embodiments, the user terminal may be a smart device such as a smart phone or a tablet running an Android or IOS operating system. The user terminal may be activated to scan one or more wireless frequency channels pre-defined by the subscribed NAN Service of the operating system to cause the user terminal to receive the broadcasted SDF by running the App installed on the user terminal.

In certain embodiments, a Service Name data field of the software application may be configured to match a Service Name data field of the SDF broadcasted by the UAV. In certain other embodiments, a Service ID data field of the software application may be configured to match a Service ID data field of the SDF broadcasted by the UAV.

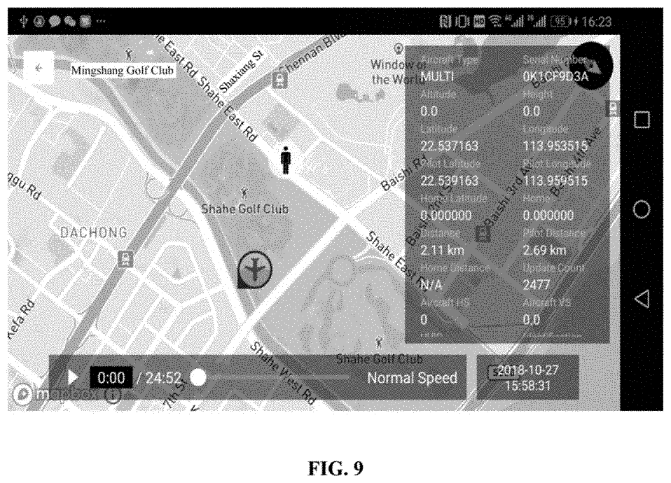

FIG. 9 shows an example of outputting the UAV monitoring message through an interface of the user terminal. As shown in FIG. 9, in certain embodiments, the information carried in the UAV monitoring message may be displayed in a graphic interface. In certain embodiments, the UAV monitoring message may include a current position of the UAV, and the monitoring message may include displaying a map on the interface of the user terminal, and displaying an icon of the UAV on the map corresponding to the current position of the UAV. In certain embodiments, the UAV monitoring message may include a type of the UAV. The icon of UAV displayed on the map may correspond to the type of the UAV. For example, a first icon may be displayed if the UAV is a first type of UAV, and a second icon may be displayed if the UAV is a second type of UAV. Thus, displaying the icon of the UAV on the map may include: displaying a first icon if the UAV is a first type of UAV; and displaying a second icon if the UAV is a second type of UAV. In certain embodiments, the UAV may be categorized by number of rotors, including a single-rotor UAV or a multi-rotor UAV. In certain embodiments, the UAV may be categorized its application purpose, such as an aerial imaging UAV, a surveillance UAV, a surveying and mapping UAV, a package delivery UAV, an agricultural UAV, and so on. In certain embodiments, one or more of the following information of the UAV monitoring message may be displayed on the interface: an operational status of the UAV, a longitude coordinate of the UAV, a latitude coordinate of the UAV, an altitude of the UAV according to the WGS 84 standard, a height of the UAV according to the barometer unit, a vertical speed of the UAV, and a horizontal speed of the UAV.

In certain embodiments, certain calculations may be performed on the user terminal device, and the calculation results may be outputted through the interface of the user terminal. The calculation may be performed for one or more of: a UAV-to-controller distance according to a current position of the UAV and a current position of a remote controller of the UAV by the user terminal; a UAV-to-take-off distance according to a current position of the UAV and a take-off position of the UAV by the user terminal; and a UAV-to-terminal distance according to a current position of the UAV and a current position of the user terminal by the user terminal. One or more of the calculated results may be displayed through the interface of the user terminal.

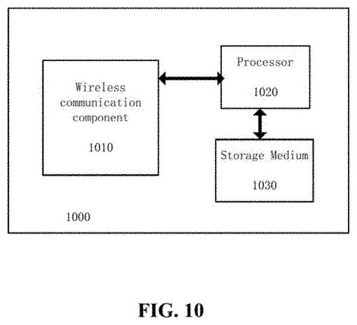

In another aspect of the present disclosure, a UAV is provided. FIG. 10 shows a configuration of a UAV according to certain embodiments. The UAV 1000 may include a wireless communication component 1010 and a processor 1020. The wireless communication component 1010 may include a Wi-Fi module that provides Wi-Fi network access. The processor 1020 may interact with the wireless communication component 1010 and configured to: acquire identification information related to the UAV; acquire status information related to the UAV; compose a Service Discovery Frame (SDF) including a UAV monitoring message according to the identification information and the status information, the SDF being compliant with a Neighbor Awareness Networking (NAN) protocol; and broadcast the SDF including the UAV monitoring message through the wi-fi communication component. In certain embodiments, the UAV may further include a storage medium 1030. The processor 1010 may read instructions from the storage medium 1030 to perform the various operations.

In certain embodiments, the processor 1020 may be configured to write the UAV monitoring message into a NAN Attribute field of the SDF. For example, it may be configured to write the UAV monitoring message into a Service Info field of the NAN Attribute field of the SDF.

In certain embodiments, the processor 1020 and the wireless communication component 1010 may be configured to broadcast the SDF in a predetermined wireless frequency channel, for example, in a 2.437 GHz frequency channel. In certain embodiments, the wireless communication component 1010 includes an omnidirectional antenna, and the SDF is broadcasted via the omnidirectional antenna.

In certain embodiments, the processor 1020 is configured to periodically broadcast the SDF with a fixed repetition frequency. In certain other embodiments, the processor 1020 is configured to broadcast the SDF with a time-varying repetition frequency correlated to a flight speed of the UAV.

In certain embodiments, the UAV monitoring message comprises a static message and a dynamic message; and the processor 1020 is configured to: broadcast the SDF carrying the static message at a first repetition frequency; and broadcast the SDF carrying the dynamic message at a second repetition frequency.

The processor 1020 may be further configured to perform other operations as described in the forgoing method for monitoring the UAV. The details are not repeated herein.

In another aspect of the present disclosure, a non-transient computer-readable medium is provided. The non-transient computer-readable medium may store computer-executable instructions that can be executed by a user terminal. In certain embodiments, the user terminal may be a user terminal, such as a smartphone or tablet. When the computer-executable instructions are executed by the user terminal, they may cause the user terminal to: receive a Service Discovery Frame (SDF) broadcasted by an unmanned aerial vehicle (UAV), the SDF being compliant with a Neighbor Awareness Networking (NAN) protocol and containing a UAV monitoring message including identification information related to the UAV and the status information related to the UAV; acquire the UAV monitoring message from the received SDF; and output the UAV monitoring message through an interface of the user terminal.

In certain embodiments, when the computer-executable instructions are executed by the user terminal, they may further cause the user terminal to: subscribe to a NAN Service via a software application installed on the user terminal; and activate the user terminal to scan one or more wireless frequency channels pre-defined by the subscribed NAN Service to cause the user terminal to receive the broadcasted SDF.

In certain embodiments, when the computer-executable instructions are executed by the user terminal, they may further cause the user terminal to: configure a Service Name data field of the software application to match a Service Name data field of the SDF broadcasted by the UAV, or configure a Service ID data field of the software application to match a Service ID data field of the SDF broadcasted by the UAV.

In certain embodiments, when the computer-executable instructions are executed by the user terminal, they may further cause the user terminal to: display a map on the interface of the user terminal; and display an icon of the UAV on the map corresponding to the current position of the UAV.

In certain embodiments, when the computer-executable instructions are executed by the user terminal, they may further cause the user terminal to: display a first icon if the UAV is a single-rotor UAV; and display a second icon if the UAV is a multi-rotor UAV.

In certain embodiments, when the computer-executable instructions are executed by the user terminal, they may further cause the user terminal to display one of more of: an operational status of the UAV, a longitude coordinate of the UAV, a latitude coordinate of the UAV, an altitude of the UAV according to the WGS 84 standard, a height of the UAV according to the barometer unit, a vertical speed of the UAV, and a horizontal speed of the UAV.

In certain embodiments, when the computer-executable instructions are executed by the user terminal, they may further cause the user terminal to calculate one or more of: a UAV-to-controller distance according to a current position of the UAV and a current position of a remote controller of the UAV by the user terminal; a UAV-to-take-off distance according to a current position of the UAV and a take-off position of the UAV by the user terminal; and a UAV-to-terminal distance according to a current position of the UAV and a current position of the user terminal by the user terminal. The user terminal is further configured to display one or more of: the UAV-to-take-off distance, the UAV-to-take-off distance, and the UAV-to-terminal distance through the interface.

The computer-executable instructions stored in non-transient computer-readable medium may further cause the user terminal to perform other operations as described in the forgoing method for monitoring the UAV. The details are not repeated herein.

In another aspect of the present disclosure, a user terminal is provided. The user terminal may include a wireless communication component and a processor. the wireless communication component may include a Wi-Fi module that provides Wi-Fi network access. the user terminal comprises: a wireless communication component; and a processor configured to: control the wireless communication component to receive a Service Discovery Frame (SDF) broadcasted by an unmanned aerial vehicle (UAV), the SDF being compliant with a Neighbor Awareness Networking (NAN) protocol and carrying a UAV monitoring message including at least one of identification information related to the UAV or the status information related to the UAV; acquire the UAV monitoring message from the received SDF; and output the UAV monitoring message through an interface of the user terminal.

The method and apparatus provided by the present disclosure according to the embodiments are described in detail above. The principles and implementation manners provided by the present disclosure are described herein by using specific examples. The description of the above embodiments is only used to help understand the method provided by the present disclosure. At the same time, a person skilled in the art will make changes the specific embodiments and the application scope according to the idea provided by the present disclosure. In summary, the contents of the present specification should not be construed as limiting the present disclosure.

Additionally, various functional units in various embodiments according to the present invention may be integrated into one processing unit, or may be physically individual. Two or more of various function units may be integrated into one unit. The above integrated unit may be implemented in a form of hardware or in a form of functional units of software.

The integrated units, if being implemented in a form of functional units of software and being independent products, may be stored in one computer-readable storage medium. Based on such understandings, some or all of the technical solutions of the present invention may be embodied in a form of a software product. The software product may be stored in a storage medium, and comprise several instructions for causing the computer processor to execute some or all of steps of the methods in various embodiments according to the present invention. The above-mentioned storage medium may comprise: a USB flash disk, a movable hard disc, a Read-Only Memory (ROM), a Random Access Memory (RAM), a diskette or an optical disc and various medium capable of storing program codes.

The foregoing disclosure is merely illustrative of the embodiments of the invention, and is not intended to limit the patentable scope of the invention. Any equivalent structural or flow variations made on the basis of the description and the drawings of the invention, and their direct or indirect applications to other relevant technical fields, shall all fall into the patentable scope of the invention.

What is claimed is:

1. A method for monitoring an unmanned aerial vehicle (UAV), comprising:
acquiring, by a processor of the UAV, a UAV monitoring message, wherein the UAV monitoring message includes information on one or more of: identification information related to the UAV and status information related to the UAV;
composing, by the processor of the UAV, a Service Discovery Frame (SDF) carrying the UAV monitoring message, the SDF being compliant with a Neighbor Awareness Networking (NAN) protocol;
broadcasting, by the UAV, the SDF carrying the UAV monitoring message;
receiving the broadcasted SDF by a user terminal;
acquiring the UAV monitoring message from the received SDF by the user terminal; and
outputting the UAV monitoring message through an interface of the user terminal.

2. The method according to claim 1, wherein:
composing the Service Discovery Frame (SDF) includes writing the UAV monitoring message into a NAN Attribute field of the SDF.

3. The method according to claim 2, wherein:
composing the Service Discovery Frame (SDF) includes writing the UAV monitoring message into a Service Info field of the NAN Attribute field of the SDF.

4. The method according to claim 1, wherein:
broadcasting the SDF carrying the UAV monitoring message includes broadcasting the SDF in a 2.437 GHz wireless frequency channel; and
the method further comprises scanning the 2.437 GHz wireless frequency channel by the user terminal to receive the broadcasted SDF.

5. The method according to claim 1, wherein:
broadcasting the SDF carrying the UAV monitoring message includes broadcasting the SDF through an omnidirectional antenna.

6. The method according to claim 1, wherein broadcasting the SDF comprises periodically broadcasting the SDF with a fixed repetition frequency.

7. The method according to claim 1, wherein broadcasting the SDF comprises periodically broadcasting the SDF with a time-varying repetition frequency correlated to a flight speed of the UAV.

8. The method according to claim 1, wherein:
the UAV monitoring message includes a static message and a dynamic message; and
broadcasting the SDF carrying the UAV monitoring message includes:
broadcasting a first SDF carrying the static message at a first repetition frequency; and
broadcasting a second SDF carrying the dynamic message at a second repetition frequency.

9. The method according to claim 8, wherein:
the static message includes information on one or more of: identification information of the UAV, a flight plan of the UAV, pilot information, and a take-off location; and
the dynamic message includes a flight status of the UAV, the flight status of the UAV including one or more of: a current position of the UAV, a current height of the UAV, a current flight velocity of the UAV, a current attitude of the UAV.

10. The method according to claim 8, wherein:
the first repetition frequency is at least (⅓) Hz; and
the second repetition frequency is at least 1 Hz.

11. The method according to claim 8, wherein the first repetition frequency and the second repetition frequency are time-varying frequencies corresponding to a flight speed of the UAV.

12. The method according to claim 1, wherein the user terminal is a smart phone or a tablet computing device.

13. The method according to claim 1, wherein the user terminal runs an Android operating system.

14. The method according to claim 1, wherein receiving the broadcasted SDF by a user terminal comprises:
subscribing to a NAN Service via a software application installed on the user terminal; and
activating, by running the software application installed on the user terminal, the user terminal to scan one or more wireless frequency channels pre-defined by the subscribed NAN Service to cause the user terminal to receive the broadcasted SDF.

15. The method according to claim 14, further comprising:
configuring a Service Name data field of the software application to match a Service Name data field of the SDF broadcasted by the UAV, or configuring a Service ID data field of the software application to match a Service ID data field of the SDF broadcasted by the UAV.

16. The method according to claim 1, wherein:
the UAV monitoring message includes a current position of the UAV; and
the method further comprises:
displaying a map on the interface of the user terminal; and
displaying an icon of the UAV on the map corresponding to the current position of the UAV.

17. The method according to claim 16, wherein:
the UAV monitoring message includes a type of the UAV; and
displaying the icon of the UAV on the map includes:
displaying a first icon if the UAV is a first type of UAV; and
displaying a second icon if the UAV is a second type of UAV.

18. The method according to claim 1, wherein outputting the UAV monitoring message through the interface comprises displaying one of more of: an operational status of the UAV, a longitude coordinate of the UAV, a latitude coordinate of the UAV, an altitude of the UAV according to the WGS 84 standard, a height of the UAV according to the barometer unit, a vertical speed of the UAV, a horizontal speed of the UAV, a type of the UAV, identification information of the UAV, a flight plan of the UAV, pilot information, and a take-off location.

19. The method according to claim 1, further comprising:
calculating, based on the UAV monitoring message, one or more of:
a UAV-to-controller distance according to a current position of the UAV and a current position of a remote controller of the UAV by the user terminal;
a UAV-to-take-off distance according to a current position of the UAV and a take-off position of the UAV by the user terminal; and
a UAV-to-terminal distance according to a current position of the UAV and a current position of the user terminal by the user terminal; and
displaying one or more of: the UAV-to-take-off distance, the UAV-to-take-off distance, and the UAV-to-terminal distance through the interface.

20. A system for monitoring an unmanned aerial vehicle (UAV), comprising the UAV and a user terminal, wherein:
the UAV is configured to:
acquire a UAV monitoring message, wherein the UAV monitoring message includes information on one or more of: identification information related to the UAV and status information related to the UAV;
compose a Service Discovery Frame (SDF) carrying the UAV monitoring message, the SDF being compliant with a Neighbor Awareness Networking (NAN) protocol; and
broadcast the SDF carrying the UAV monitoring message; and
the user terminal is configured to:
receive the broadcasted SDF;
acquire the UAV monitoring message from the received SDF; and
output the UAV monitoring message through an interface of the user terminal.
